(19) United States
(12) Patent Application Publication
(10) Pub. No.: US 2020/0047216 A1
(43) Pub. Date: Feb. 13, 2020

(54) METHOD FOR GENERATING MOTOR VIBRATION WAVE

(71) Applicant: AAC Technologies Pte. Ltd., Singapore city (SG)

(72) Inventors: Zheng Xiang, Shenzhen (CN); Hanlin Deng, Shenzhen (CN); Xiang Lu, Shenzhen (CN)

(21) Appl. No.: 16/528,704

(22) Filed: Aug. 1, 2019

(30) Foreign Application Priority Data
Aug. 13, 2018 (CN) 201810918779.3

(51) Int. Cl. B06B 1/02; H02P 25/032; B06B 3/00; G08B 6/00; H02P 25/06; G01P 15/00

(52) U.S. Cl. CPC B06B 1/0238; H02P 25/032; B06B 3/00; H02P 2209/13; H02P 25/06; G01P 15/00; G08B 6/00

(57) ABSTRACT

The present disclosure provides a method for generating a motor vibration wave, including the following steps: step S1: exciting a motor by a white noise signal, and measuring a vibration signal of the motor by an acceleration sensor; and step S2: obtaining an impulse response of system based on the vibration signal obtained by the acceleration sensor; and step S3: constructing an expected vibration waveform; and step S4: performing Wiener inverse filtering on the vibration waveform obtained in step S3 to obtain a frequency-domain signal; and step S5: performing inverse fast Fourier transform on the frequency-domain signal obtained in step S4 to obtain an excitation signal in time domain. With such method for generating a motor vibration wave provided by the present disclosure, the expected vibration waveform can be automatically generated and conveniently extracted.

### FIELD OF THE PRESENT DISCLOSURE

The present disclosure relates to microelectromechanical field, more particularly to a method for generating a motor vibration wave.

### DESCRIPTION OF RELATED ART

In recent years, Linear Resonant Actuator (LRA) has become more and more popular in the fields of smart phone and tablet computer, etc. This kind of actuator, also known as a motor, is easy to achieve a more elegant and comfortable tactile experience because of its quick response to an excitation signal. Most of the time, we need to design motor excitation signals to obtain expected vibration waveforms for different application scenarios. However, it is inconvenient for extracting a motor vibration wave in related art.

Therefore, it is necessary to provide a new method for generating a motor vibration wave to solve above mentioned problem.

### BRIEF DESCRIPTION OF THE DRAWINGS

FIG. 1 is a flowchart of a method for generating a motor vibration wave according to the present disclosure;

FIG. 2 is a schematic diagram of Wiener inverse filtering of the method for generating the motor vibration wave according to the present disclosure.

### DETAILED DESCRIPTION OF THE EXEMPLARY EMBODIMENT

Hereinafter, the present disclosure will be further described with reference to the accompanying drawings and embodiments.

The method for generating a motor vibration wave of the present embodiment is applied to linear motors which are equiped in the smart phone or the tablet computer, to generate a motor automatic waveform, and the method is simple and easy to extract.

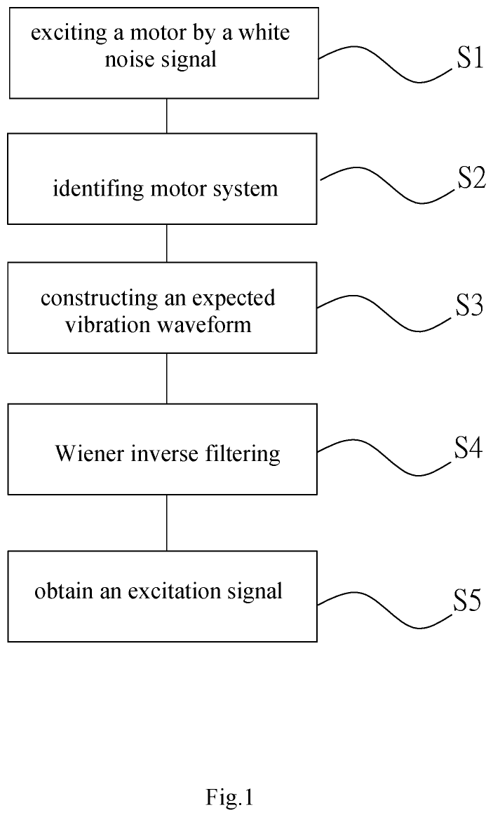

As shown in FIG. 1, the method for generating the motor vibration wave of the present disclosure comprises the following steps:

Step S1, a motor is excited by a white noise signal: a motor is excited by the white noise signal, and a vibration signal of the motor is measured by an acceleration sensor.

Step S2, identifying a motor system: according to the Wiener Hopf equation, an impulse response h[n] of the system can be solved by solving the autocorrelation Rxx of the inputted noise signal and the cross-correlation Rxy of the input and output. Since the autocorrelation of the white noise is a pulse signal, thus the impulse response of the system can be obtained directly, i.e., h[n]=(1/sigma)*Rxy, where, the sigma is an energy value of the white noise used in step S1.

Step S3, constructing an expected vibration waveform: the expected vibration waveform is drawn by means of dotting or hand drawing, preferably, a time length unit is ranged from 5 ms to 15 ms. The expected vibration waveform can be constructed to reach an optimal display effect under such time length unit state,

Step S4, Wiener inverse filtering: the Wiener inverse filtering is performed on the vibration waveform obtained in step S3 t to obtain a frequency domain signal, that is, by solving the restoration function, an estimated value of the input f(x, y) of a degradation function H is obtained, and the frequency domain of the obtained frequency-domain signal is expressed in the following Formula:

$$\hat{F} ( u , v ) = \frac{{H}^{*} ( u , v )}{{\vert H ( u , v ) \vert}^{2} + {P}_{N} ( u , v ) / {P}_{S} ( u , v )} G ( u , v ) ,$$

where, the * refers to a signal conjugation, the P_{N}(u,v)/(P_{S}(u,v) is the power ratio between noise and signal. Specifically, the power ratio between noise and signal P_{N}(u,v)/P_{S}(u,v) is a constant.

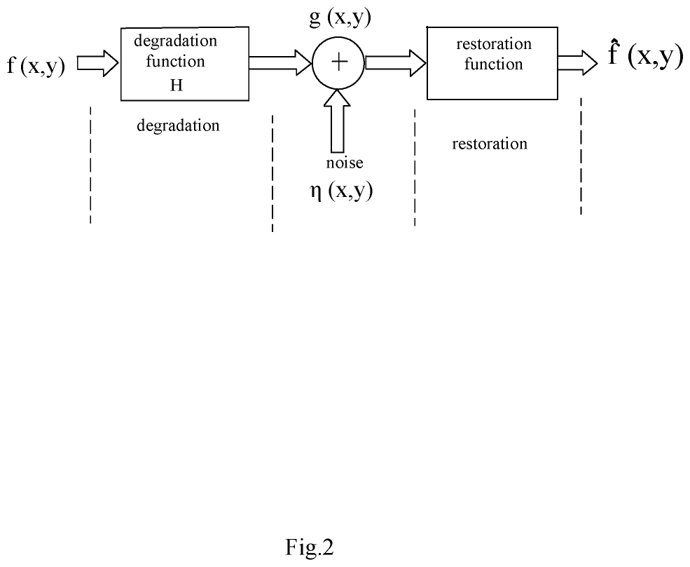

FIG. 2 is the schematic diagram of the Wiener inverse filtering. The

Wiener inverse filtering, i.e., an estimated value of the input f(x, y) of the degenerate function H can be obtained by solving the restoration function, and g(x, y) is regarded as the expected amount of vibration, and the motor is regarded as a degenerative function H, i.e., an estimation to the excitation signal f(x, y), and thus the above mentioned frequency domain is expressed in the following Formula:

$$\hat{F} ( u , v ) = \frac{{H}^{*} ( u , v )}{{\vert H ( u , v ) \vert}^{2} + {P}_{N} ( u , v ) / {P}_{S} ( u , v )} G ( u , v ) .$$

Step S5, generating an excitation signal: the excitation signal in time-domain form is obtained by performing the inverse fast Fourier transform on the frequency domain signal obtained in step S4.

The present application provides a method for generating the motor vibration wave,comprising the following steps: step S1: exciting a motor by a white noise signal, and measuring a vibration signal of the motor by an acceleration sensor; step S2: obtaining an impulse response of system with the vibration signal obtained by the acceleration sensor; step S3: constructing an expected vibration waveform; step S4: performing the Wiener inverse filtering on the vibration waveform obtained in step S3 to obtain a frequency domain signal; step S5: performing the inverse fast Fourier transform on the frequency-domain signal obtained in step S4 to obtain an excitation signal in time-domain. By provided the above mentioned method, the motor vibration wave in the present disclosure can be automatically generated and conveniently extracted.

The above is only the embodiment of the present invention, but not limit to the patent scope of the present disclosure, and the equivalent structures or equivalent process transformations made by utilizing the present disclosure and the contents of the drawings, or directly or indirectly applied to other related technology fields, are all included in the scope of the patent protection of the present disclosure.

What is claimed is:

1. A method for generating a motor vibration wave, comprising the following steps:
step S1: exciting a motor by a white noise signal, and measuring a vibration signal of the motor by an acceleration sensor; and
step S2: obtaining an impulse response of system with the vibration signal obtained by the acceleration sensor;
step S3: constructing an expected vibration waveform;
step S4: performing Wiener inverse filtering on the vibration waveform obtained in step S3 to obtain a frequency-domain signal; and
step S5: performing inverse fast Fourier transform on the frequency-domain signal obtained in step S4 to obtain an excitation signal in time domain.

2. The method according to claim 1, wherein in step S2, solving an impulse response of the system h[n], by using Wiener hopf equation, by solving an autocorrelation Rxx of an inputted noise signal and a cross-correlation Rxy of an input and output.

3. The method according to claim 2, wherein the impulse response of the system is h[n]=(1/sigma)*Rxy, where, the sigma is an energy value of the white noise.

4. The method according to claim 1, wherein in the step S3, drawing the expected vibration waveform by means of dotting or hand drawing.

5. The method according to claim 4, wherein a time length unit of the expected vibration waveform is ranged from 5 ms to 15 ms.

6. The method according to claim 1, wherein in the step S4, obtaining an estimated value of an input f(x, y) of a degradation function H by solving a restoration function.

7. The method according to claim 6, wherein a frequency domain expression of the frequency domain signal is:
$$\hat{F} ( u , v ) = \frac{{H}^{*} ( u , v )}{{\vert H ( u , v ) \vert}^{2} + {P}_{N} ( u , v ) / {P}_{S} ( u , v )} G ( u , v ) ,$$
where, the * indicates a signal conjugation, and the P_{N}(u,v)/P_{S}(u,v) is a power ratio between noise and signal.

8. The method according to claim 7, wherein a value of P_{N}(u,v)/ P_{S}(u,v) is a constant.
